(19) United States
(12) Patent Application Publication
(10) Pub. No.: US 2024/0246025 A1
(43) Pub. Date: Jul. 25, 2024

(54) APPARATUS AND PROCESS FOR SEPARATING CARBON AND HYDROGEN IN A HYDROCARBON-CONTAINING GAS MIXTURE

(71) Applicant: ECOOL ADVANCED URBAN ENGINEERING GMBH, Innerschwand am Mondsee (AT)

(72) Inventors: Ursula HOFBAUER, Wien (AT); Dragos Alexandru BAUR, Pralea (RO)

(21) Appl. No.: 18/562,671

(22) PCT Filed: Jun. 3, 2022
(86) PCT No.: PCT/EP2022/065204

§ 371 Date: Nov. 20, 2023

(30) Foreign Application Priority Data
Jun. 7, 2021 (AT) A 50456/2021

(51) Int. Cl. B01D 53/24; C01B 3/24; C01B 3/50

(52) U.S. Cl. CPC B01D 53/24; C01B 3/24; C01B 3/50; B01D 2256/16; C01B 2203/0272; C01B 2203/041

(57) ABSTRACT

An apparatus for separating carbon and hydrogen in a hydrocarbon-containing gas mixture, in particular natural gas, has a rotationally-symmetrical housing with an essentially toroidal separating space with a vertical central axis. The housing has an upper part, a side wall, a lower part for extracting carbon, and a dip pipe located in the vertical central axis with an opening for extracting the hydrogen. Emptying into the upper part are two or more nozzles with a nozzle opening for injecting the gas mixture into the separating space, whose nozzle axis defining a beam axis has a component that is tilted in the peripheral direction of the separating space, a component that is tilted radially outward, and a component that is tilted in the vertical direction.

### CROSS-REFERENCE TO RELATED APPLICATIONS

This application is the US national stage of PCT/EP2022/065204, filed Jun. 3, 2022 and designating the United States, which claims the priority of AT A 50456/2021, filed Jun. 7, 2021. The entire contents of each foregoing application are incorporated herein by reference.

### BACKGROUND OF THE INVENTION

### Field of the Invention

The invention relates to an apparatus and a process for separating carbon and hydrogen in a hydrocarbon-containing gas mixture, in particular natural gas, under the action of centrifugal forces.

### Description of the Related Art

Known from the state of the art are various processes for thermal or catalytic separation of hydrogen and carbon from natural gas, which, however, are unsatisfactory, on the one hand with respect to the energy demand and on the other hand with respect to the speed of the process.

### SUMMARY OF THE INVENTION

The object of the invention is therefore to provide an improved apparatus and an improved process for separating carbon and hydrogen in a hydrocarbon-containing gas mixture.

This object is achieved with an apparatus and with a process as disclosed and claimed.

According to the invention, the gas mixture is separated in a centrifugal separator into carbon and hydrogen, with which a continuous process with relatively low energy consumption is possible.

Preferred embodiments of the invention are also disclosed.

In the invention, it has turned out to be good practice for the nozzles to be directed onto the area of the maximum outside diameter of the separating space, optionally also the area located immediately below and/or above. In the case of such a design, very high rotation speeds can be achieved in the separating space around the vertical central axis (“swirl flow”) and around the central circle of the toroidal separating space (“tumble flow”) with a reliable separation of hydrogen and carbon.

In order to efficiently produce the rotation around the vertical central axis, the nozzles are especially preferably oriented so that their beam directions defined by the nozzle axes are oriented in the outline (i.e., in a normal projection parallel to the vertical central axis) tangentially to coaxial circles around the central axis, which are produced by horizontal cuts of the torus shell (i.e., of the housing bounding the toroidal separating space).

In this case, the nozzle opening of at least one nozzle, preferably of a first group of nozzles, can be located on a first circle, and the nozzle opening of at least one nozzle, preferably of a second group of nozzles, can be located on a second circle with another diameter.

The preferred range of the diameter of this or these circles is between the circle diameter of the central circle of the torus and a circle with a circle diameter that is approximately ⅓ larger.

In this case, it has turned out to be especially advantageous when the maximum outside diameter lies in a normal plane to the vertical central axis and when the area in which the nozzles are directed lies at an angle of 0° to 14°, above the normal plane, which is at the height of the maximum outside diameter, wherein the tip of the angle is at the point of intersection of the normal plane and the vertical central axis, and the angle from the normal plane is measured.

In addition or alternately, it has turned out to be especially advantageous when the projection of the direction of the respective nozzle axis onto the normal plane lies at an angle of between 36° and 47° relative to the respective vertical plane, in which the vertical central axis and the impact point of the respective nozzle axis are located on the housing.

These areas or angles have turned out to be especially effective in order to achieve a high rotation speed of the gas mixture both in the vertical direction (“tumble flow”) and in the horizontal direction (“swirl flow”).

In order to provide an especially symmetrical separating space that is brought as well as possible to an exact torus, which separating space has as few geometric properties as possible that disrupt the gas circulation, the separating space on the side opposite to the upper part is bounded by a base plate, which has a first recess that is in the shape of an arc of a circle in cross-section, and which forms a section of the surface of the torus.

### BRIEF DESCRIPTION OF THE DRAWINGS

Additional features and advantages of the invention are given in the description below of preferred embodiments of the invention that do not limit the scope of protection, with reference to the accompanying drawings. Here:

FIG. 1 shows an axonometric view of a first embodiment of an apparatus according to the invention,

FIG. 2 shows a vertical view of the apparatus of FIG. 1,

FIG. 3 shows in section an enlarged view of the apparatus according to the invention from above,

FIG. 4 shows a vertical cut through the apparatus according to the invention,

FIG. 5 shows in section an enlarged detail of the apparatus according to the invention,

FIG. 6 shows in section an additional enlarged detail of the apparatus according to the invention,

FIG. 7 shows a diagrammatic top view for illustrating the position of the nozzle axes,

FIG. 8 shows a diagrammatic vertical view for illustrating the position of the nozzle axes,

FIG. 9 shows an axonometric view of a second embodiment of an apparatus according to the invention,

FIG. 10 shows a vertical cut through the apparatus of FIG. 9,

FIG. 11 shows a vertical cut through the lower part of the apparatus with a carbon extraction system,

FIG. 12 shows a vertical cut through the upper part of the apparatus according to the invention with a system for heating the hydrocarbon-containing gas mixture,

FIG. 13 shows a horizontal cut through the upper part of the apparatus according to the invention with a burner,

FIG. 14 shows a top view of the apparatus according to the invention, and

FIG. 15 shows a cut through a system for separating a hydrocarbon-containing gas mixture and hydrogen.

### DETAILED DESCRIPTION

Depicted in the drawings are embodiments of an apparatus 1 according to the invention, which, however, are intended only as examples, and, aside from the features according to the invention as defined in the claims, can also be implemented differently within the scope of this invention as regards many components, without this requiring special mention below.

The apparatus 1 according to the invention for separating carbon and hydrogen in a hydrocarbon-containing gas mixture, in particular natural gas, under the action of centrifugal forces has a rotationally-symmetrical housing 2 with an essentially toroidal separating space 3 with a vertical central axis 4. In the depicted embodiment, the housing 2 has an upper part 5, a side wall 6, a lower part 7 for extracting carbon, and a dip pipe 8 located in the vertical central axis 4 with an opening 9 for extracting the hydrogen. The upper part 5, the side wall 6, and the lower part 7 can be, but do not necessarily have to be, produced from separate parts. For example, the side wall 6 can also be formed from sections of the upper part 5 and/or the lower part 7 and does not have to have the depicted cylindrical shape of the wall.

The dip pipe 8 extends through a central recess 13 of the upper part 5, wherein the opening 9 of the dip tube 8 is arranged at a distance from a base plate 11.

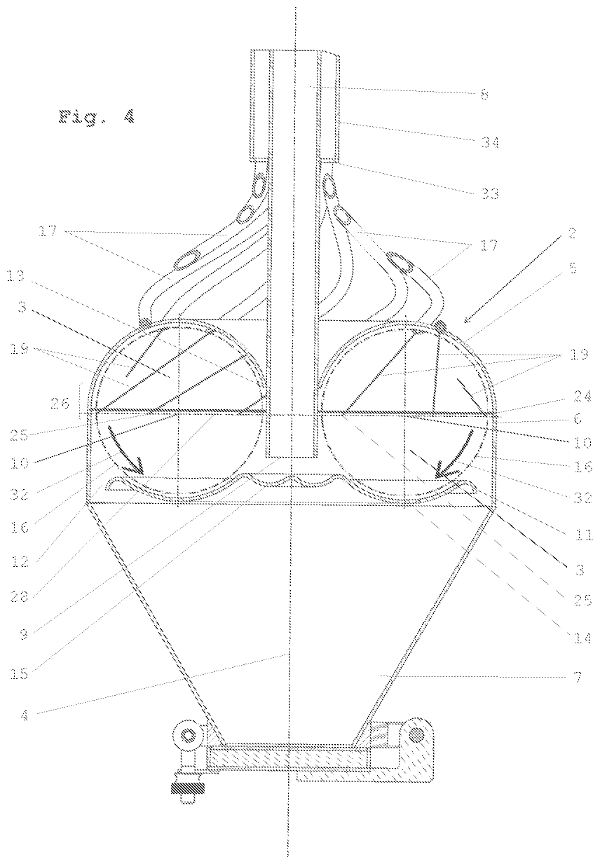

The base plate 11 has a first or outer recess 14 in the shape of an arc of a circle in cross-section, which recess forms a circular trough in top view, which trough together with the upper part 5 and the dip pipe 8 as well as the side wall 6 bounds the separating space 3 designed as a rotation torus with a central circle 10, as is indicated by the dashed-dotted lines 16 in FIG. 4. Between the side wall 6 and the outer edge of the base plate 11, there is an annular gap 12, through which the deposited carbon is extracted downward.

The base plate 11 has in addition a second or inner recess 15, which also forms a circular trough in top view and is in the shape of an arc of a circle in cross-section. The recess 15 is located under the opening 9 of the dip pipe 8 and makes possible an especially aerodynamically-efficient entrance of the gas stream into the dip pipe 8.

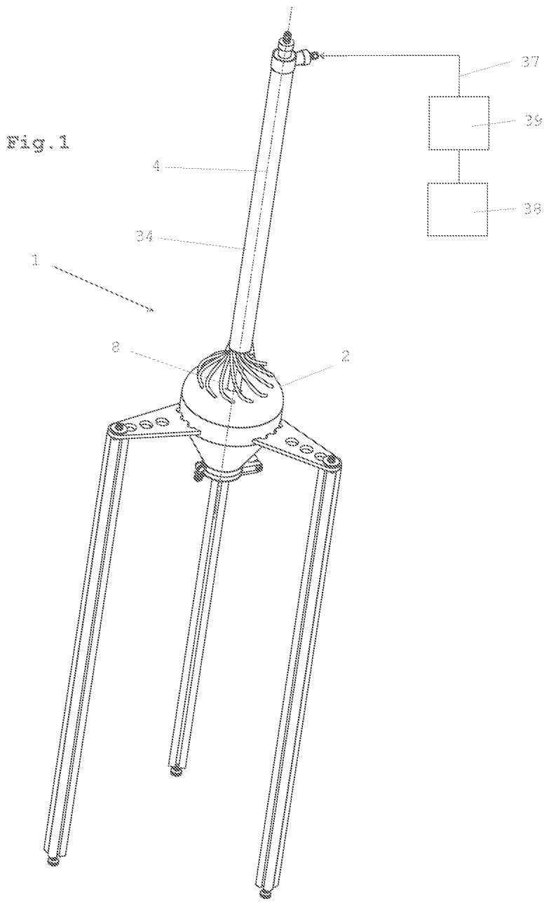

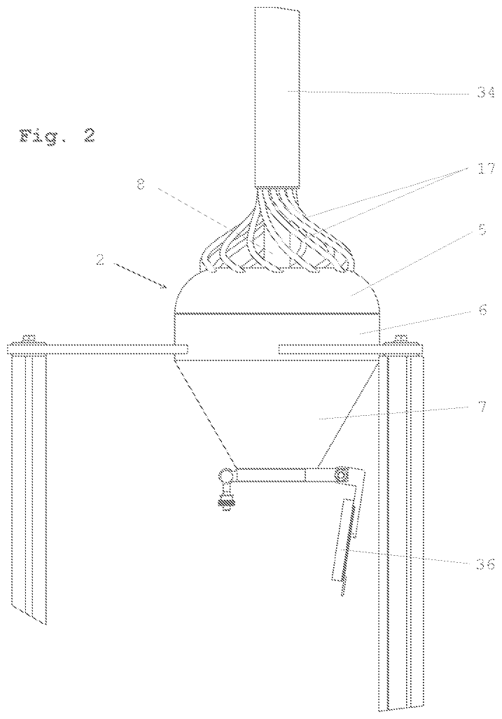

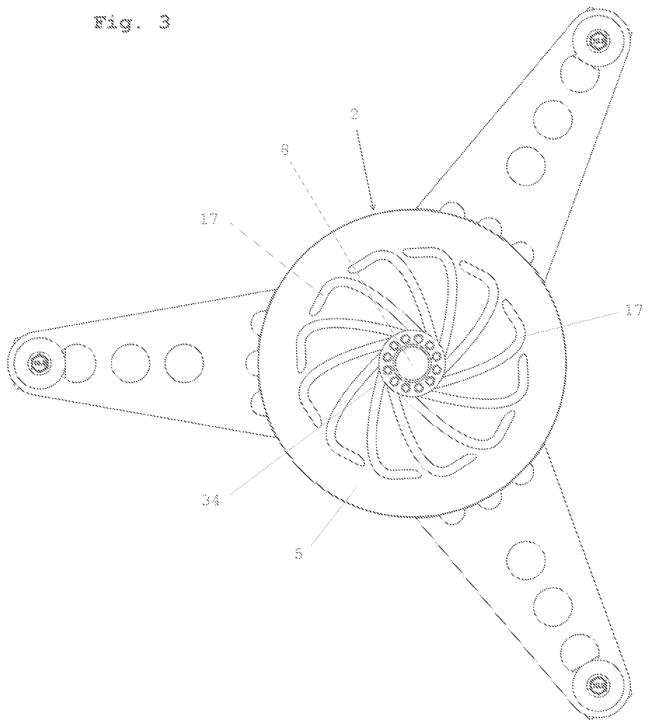

Feed lines 17 for the hydrocarbon-containing gas mixture in the separating space 3 are connected to the upper part 5, which feed lines empty into the separating space 3 via nozzles 18 with a nozzle axis 19. In the embodiment of the apparatus 1 according to the invention, depicted in FIGS. 1 to 5, twelve feed lines 17 with nozzles 18 are present, which all are connected to the upper part 5 at an equal distance from the central axis 4. However, more or fewer feed lines 17 with nozzles 18 may also be present.

The nozzle openings 20 of the nozzles 18 all lie on a circle, whose midpoint lies in the vertical central axis 4.

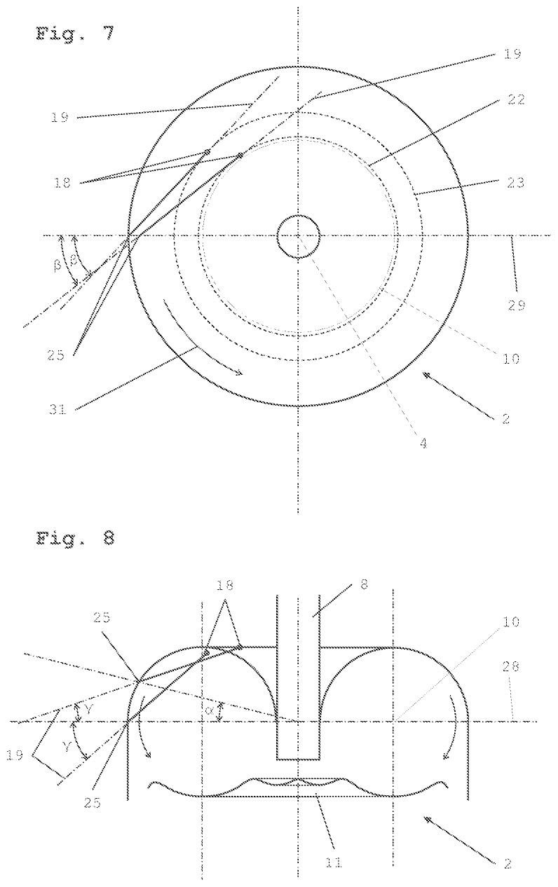

It is also possible, however, that the nozzle openings 20 of the nozzles 18 are connected to the upper part 5 at various intervals from the central axis 4, for example in parallel, annular rows, as is depicted in FIG. 7 by the dashed-dotted circles 22, 23.

In this case, two groups of nozzles 18 are present, which lie on circles 22, 23 with diameters of different sizes. The nozzles 18 are oriented so that their beam direction defined by the nozzle axes 19 has a component that is tilted in the peripheral direction of the separating space 3, i.e., a rotation around the central axis 4, and a component that is tilted in the vertical direction, i.e., parallel to the central axis 4. In addition, the nozzle axes 19 have a component that is tilted radially outward.

The nozzle axes 19 of the nozzles 18 are preferably oriented so that they lie in a normal projection onto the normal plane 28 tangentially to the respective circle 22, 23.

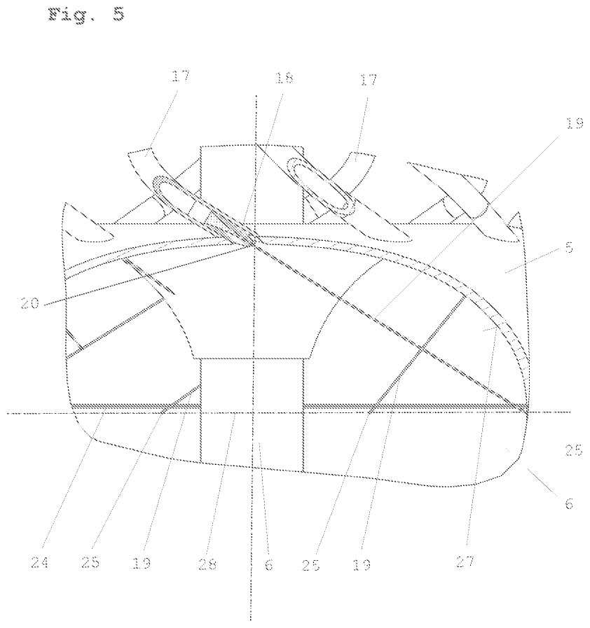

The separating space 3 has a maximum outside diameter that in the depicted embodiment of the invention lies on or just below the abutting edge 24, on which the upper part 5 and the side wall 6 adjoin. In a preferred embodiment of the invention, the nozzle axes 19 are essentially directed specifically toward this maximum outside diameter of the separating space 3, as is depicted in particular in FIG. 5. That is to say that the impact points 25 of the nozzle axes 19 are located on a line on which a normal plane 28 on the central axis 4 intersects an inside surface 27 of the separating space 3.

Within the framework of the invention, however, it is also possible that the area 26 in which the nozzles 18 are directed, i.e., the area in which the impact points 25 of the nozzle axes 19 are located on the inside surface 27 of the separating space 3, can be extended approximately above or below the maximum outside diameter, wherein not all nozzles 18 have to be oriented the same.

In particular, the area 26, onto which some or all nozzles 18 or their nozzle axes 19 are directed, can lie at an angle α of between 10°, preferably 5°, in particular 0°, below the normal plane 28, and 20°, preferably 17°, in particular 14°, above the normal plane 28. The deviation of the impact points 25 above or below the normal plane 28 can be produced in particular depending on the geometry of the separating space 3 and the flow rate at which the gas exits from the nozzles 18. The angle α is determined in such a way that its tip is at the point of intersection of the normal plane 28 and the vertical central axis 4, and the angle from the normal plane 28 is measured.

Accordingly, in a projection of a respective nozzle axis 19 onto a vertical plane 29, in which the central axis 4 and the impact point 25 of the respective nozzle axis 19 are located, preferably an angle γ between the nozzle axis and the normal plane 28 of between 34° and 42° is obtained.

To the extent that the component of the nozzle axes 19 that is tilted in the peripheral direction is affected, the latter according to the invention preferably lies at an angle ß that is between 26° and 57°, preferably between 31° and 52°, in particular between 36° and 47°. The angle β lies between the vertical plane 29, in which the vertical central axis 4 and the respective impact point 25 of the respective nozzle axis 19 are located on the inside surface 27 of the housing, and the projection of the respective nozzle axis 19 onto the normal plane 28. This can be seen in particular in FIG. 7. Also, here, various optimum angles ß are obtained, in particular depending on the geometry of the separating space 3 and the flow rate at which the gas exits from the nozzles 18.

The indicated, preferred angle ranges additionally depend on the intervals between the nozzles 18 attached on the upper part from the central axis 4. Nozzles 18 located closer to the central axis 4 are generally (but do not necessarily have to be) smaller angles than nozzles 18 located further removed from the central axis 4.

Because of the beam direction of the nozzles 18, depicted in the drawings and described above, i.e., the orientation of the nozzle axes 19, a rotation of the gas entering into the separating space 3 through the nozzles 18 is produced both in the peripheral direction around the central axis 4 (arrow 31 in FIG. 7) and also in the vertical direction (arrows 32 in FIG. 4). This has the effect that the carbon of the gas mixture is pressed onto the inside surface 27 of the upper part 5 and the side wall 6 by centrifugal force and drops through the annular gap 12 into the lower part 7 of the housing 2.

The gaseous part of the gas mixture, in particular the hydrogen of the gas mixture and optionally additional gaseous components, is diverted inward through the dip pipe 8 because of the lower specific weight.

In the depicted embodiment of the invention, the feed lines 17 are connected to a housing-side end 33 of a sheath 34, which surrounds the dip pipe 8 above the upper part 5. By the feeding of the gas mixture through the annular gap 12 formed between the dip pipe 8 and the sheath 34, a heat exchange can result between the gas flowing in through the annular gap 12 and the gas flowing out through the dip pipe 8. On the upper end of the dip pipe is arranged a connector 21 for a line for diverting the gaseous part from the separating space 3 or the dip pipe 8.

Attached on the upper end of the sheath 34 is a connector 35 for a connecting line 37, via which the hydrocarbon-containing gas mixture heated by a heating system 38 and compressed in a compressor 39 is fed at a temperature of preferably 600° C. to 1,200° ° C. At a temperature of approximately 1,200° C., the hydrocarbon-containing gas mixture essentially completely breaks down into carbon and hydrogen, so that in the separating space 3, the carbon portion can be separated from the gaseous portion (primarily hydrogen) by centrifugal force. At temperatures below 1,200° ° C. but above 600° C., the gas mixture only partially breaks down, so that the pure hydrogen and hydrocarbon-containing gas mixture are diverted through the dip pipe 8. The higher the temperature, the higher the portion of separated hydrogen and carbon as well and thus the more efficient the separating apparatus according to the invention. The spatial structure of the separated carbon can also be affected by the temperature.

The gas mixture is fed preferably at a pressure of 1.5 to 2.5 bar, wherein the separation of the carbon from hydrogen is done in the separating space 3. In this case, at the openings of the nozzles 18, preferably flow rates of 60 m/s to 70 m/s are achieved, and in the area of the central circle 10 of the toroidal separating space 3, flow rates of 15 m/s to 22 m/s are achieved, with which a quick and reliable separation of hydrogen and carbon is possible.

The process according to the invention can, of course, also be carried out at lower or higher flow rates.

In order to be able to maintain the desired pressure level in the separating space 3, a flap 36 is attached to the bottom side of the lower part 7 in the embodiment depicted in FIGS. 1, 2, and 4, which flap is opened at regular intervals in order to be able to extract the separated carbon from the housing 2.

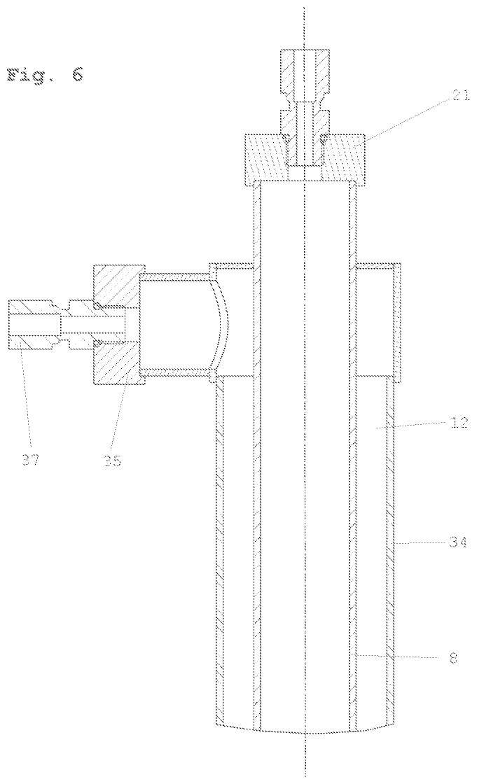

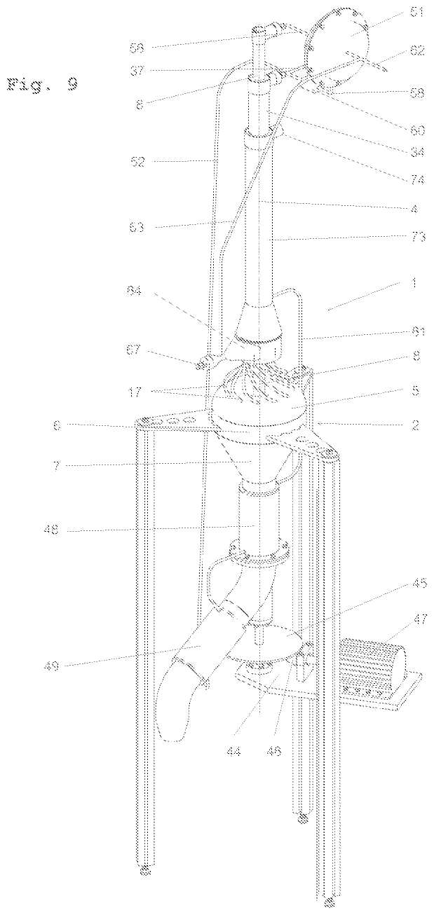

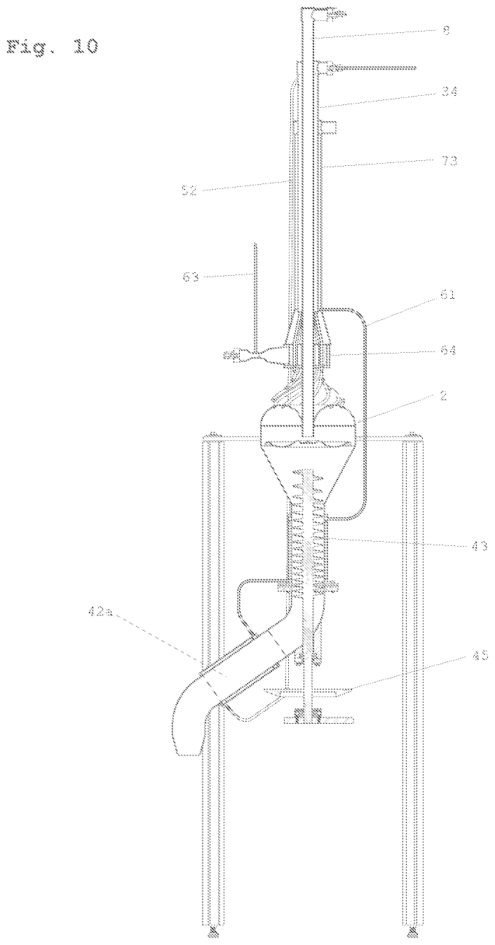

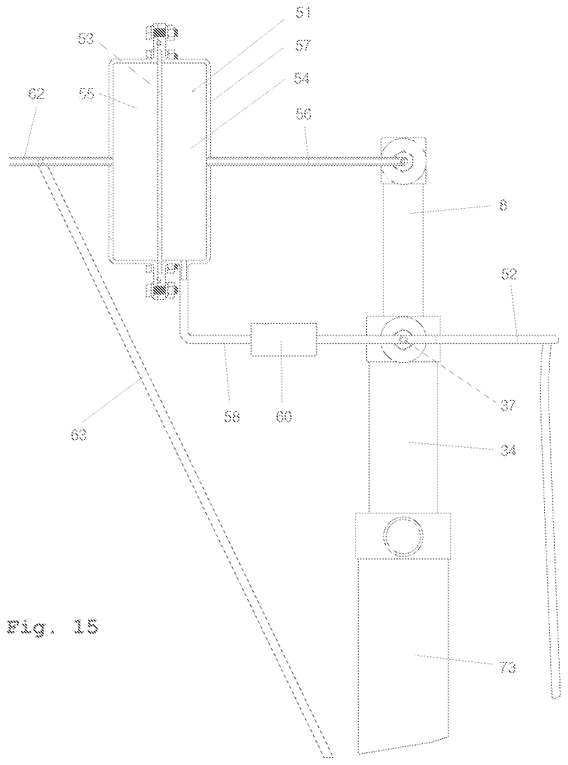

In FIGS. 9 to 15, an improved embodiment of the invention is depicted, which embodiment is constructed in principle like the embodiment described in connection with FIGS. 1 to 8. Identical components are therefore also referred to with identical reference numbers. Components that deviate structurally from one another can, however, be combined randomly.

This additional embodiment of the invention has a system 41 for continuous extraction of carbon from the lower part 7 of the housing 2. A vertical pipe 42, in which a screw 43 rotates with a pitch decreasing from top to bottom, is adjacent to the lower part 7. Because of the decreasing pitch, the carbon conveyed downward by the rotation of the screw 43 is increasingly compressed, thus sealing the housing 2 downward. In this way, a continuous operation of the apparatus 1 according to the invention is ensured, since the operation does not have to be interrupted by repeated opening of the lower part 7 for extracting the carbon.

The screw 43 is driven via a bevel gear 44 with a crown wheel 45 and a pinion gear 46, which is driven by an electric motor 47.

In order to avoid unnecessary losses of heat by extracting hot carbon, heat exchangers 48 and 49 are attached both to the vertical pipe 42 and to the adjacent pipe 42a. The hydrocarbon-containing gas mixture flows through the heat exchangers 48, 49, which gas mixture comes from a separating system 51 and under the pressure of the gas feed line 37 flows through a line 52 into the first lower heat exchanger 48, then enters via another line 59 into the second upper heat exchanger 49, also flows through the latter, and then empties via a line 61 into the sheath 34, where it mixes with the gas mixture that is already preheated in the annular gap 12 and is fed to the heating apparatus 64. In the heating apparatus 64, the gas mixture is then heated to a temperature at which the hydrocarbon-containing gas mixture breaks down into carbon and hydrogen, whereupon the gas mixture moves through the feed lines 17 into the separating space 3, in which the carbon is separated from the gas portion.

The separating system 51 depicted in section in FIG. 15 serves to separate hydrogen from the gas mixture, which is diverted by the dip pipe 8 from the separating space 3. The separating system 51 has a housing 57, in which a membrane 53 is arranged, which separates the inside space of the housing 57 into a first area 54 and a second area 55. The membrane 53 is permeable to hydrogen but not to hydrocarbon compounds. The gas mixture rising through the dip pipe 8 enters via a line 56 into the first area 54 of the housing 57, whereupon hydrogen can diffuse through the membrane 53 into the second area 55, and flows out from there via a drain pipe 62. It is understood that the hydrogen can also be separated from the gas mixture by any other known method.

The hydrocarbon-containing gas portion, which is retained in the first area 54, is diverted by means of a pump 60 through a line 58 and is fed, along with fresh gas that is fed via the connecting line 37, via the sheath 34 again to the separating space 3. A part of the gas diverted through the line 58 is fed as described above via the line 52 to the heat exchangers 48, 49.

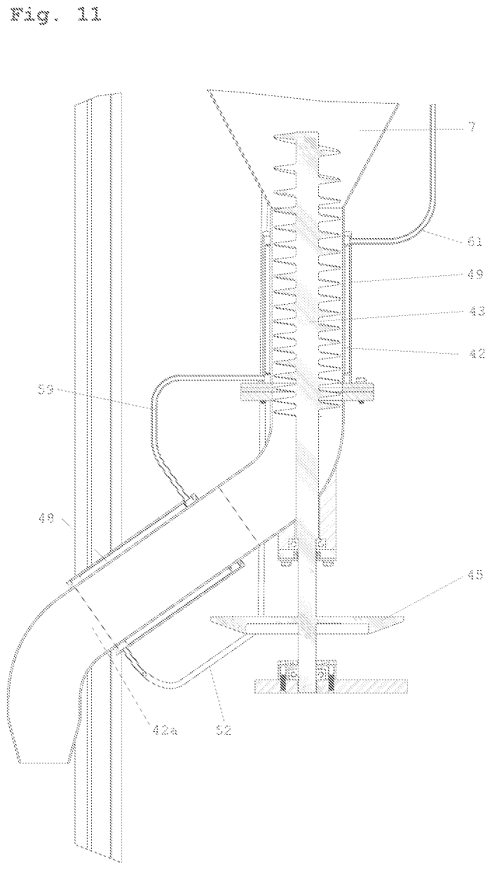

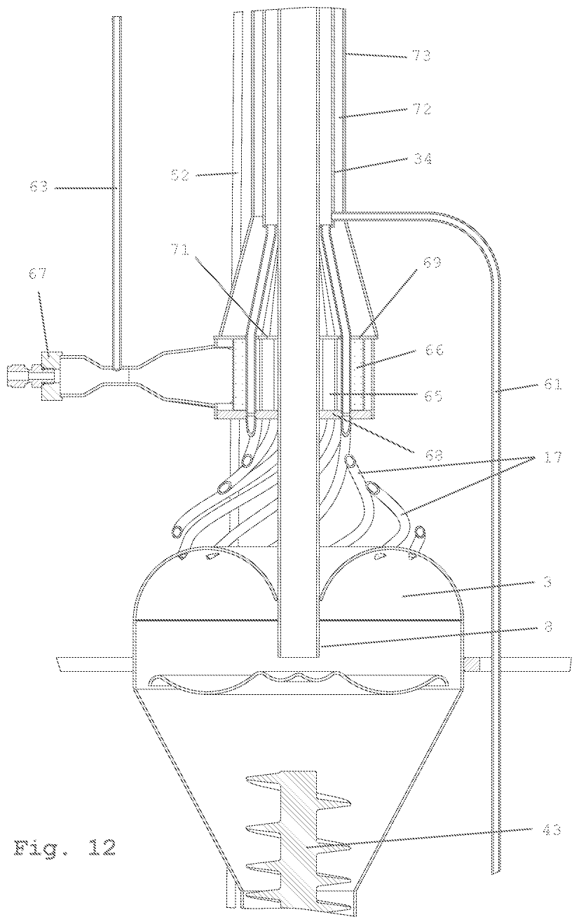

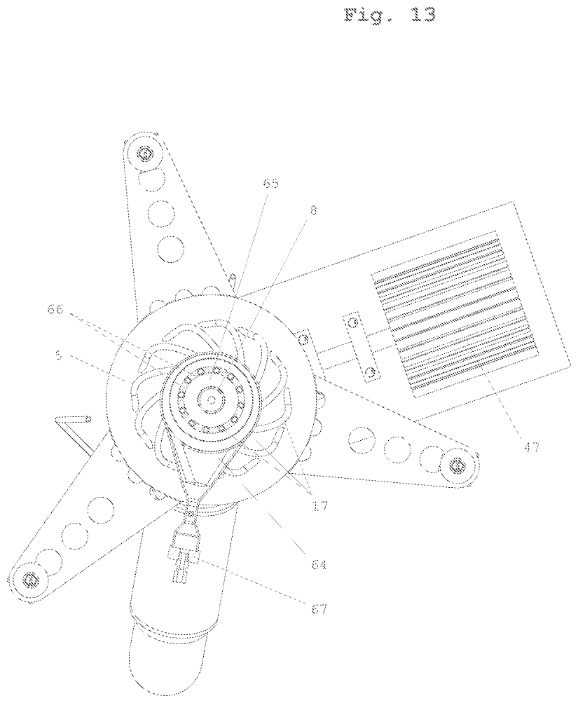

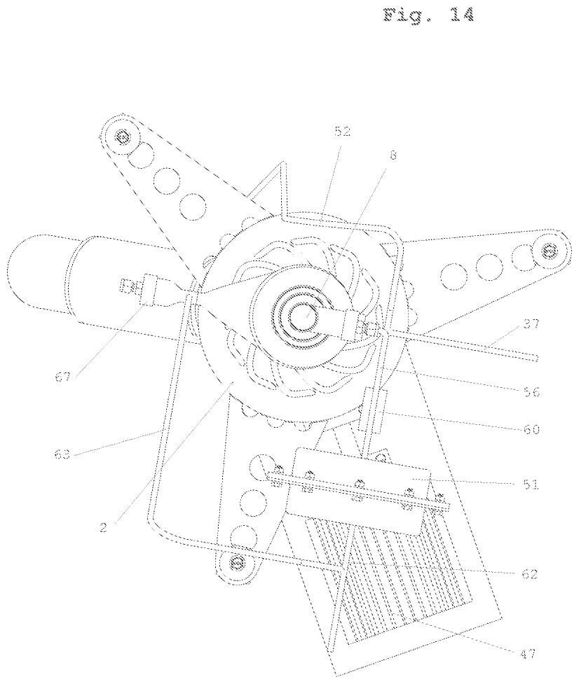

A supply line 63, which runs to a heating apparatus 64 or a burner, which is depicted in detail in FIGS. 12 and 13, branches off from the drain pipe 62 for the pure hydrogen. The heating apparatus 64 can be provided in addition to or as an alternative to a heating system 38, as was described in connection with the embodiment according to FIG. 1.

The heating apparatus 64 has a combustion chamber 65, which is bounded by spacers 66 that are arranged between the feed lines 17. Located between the spacers 66 and the feed lines 17 are small gaps, which can have, for example, a width of 0.2 mm, and through which move the hydrogen fed by the supply line 63 as well as oxygen or air in the combustion chamber 65 fed by the connector 67. The combustion chamber 65 is in addition bounded downward by a base 68 and upward by a cover 69, which has an opening 71 in the center for diverting the combustion gases.

The combustion gases first heat the feed lines 17 in the immediate area of the combustion chamber 65 and rise, after they have exited through the opening 71, into an annular space 72 between the sheath 34 and an outside pipe 73. While the hot combustion gases rise in the annular space 72, they heat in addition the hydrocarbon-containing gas mixture fed by the sheath 34, until they are diverted through an outlet 74.

Reference Symbol List:

| | |
|---|---|
| 1 | Apparatus |
| 2 | Housing |
| 3 | Separating space |
| 4 | Axis |
| 5 | Upper part |
| 6 | Side wall |
| 7 | Lower part |
| 8 | Dip pipe |
| 9 | Opening |
| 10 | Central circle |
| 11 | Base plate |
| 12 | Annular gap |
| 13 | Recess |
| 14 | First recess in the shape of an arc of a circle |
| 15 | Second recess in the shape of an arc of a circle |
| 16 | Dashed-dotted lines |
| 17 | Feed lines |
| 18 | Nozzles |
| 19 | Nozzle axis |
| 20 | Nozzle opening |
| 21 | Connector |
| 22 | Circle |
| 23 | Circle |
| 24 | Abutting edge |
| 25 | Impact point |
| 26 | Area |
| 27 | Inside surface |
| 28 | Normal plane |
| 29 | Vertical plane |
| 30 | — |
| 31 | Arrow |
| 32 | Arrows |
| 33 | End |
| 34 | Sheath |
| 35 | Connector |
| 36 | Flap |
| 37 | Connecting line |
| 38 | Heating system |
| 39 | Compressor |
| 40 | — |
| 41 | System |
| 42 | Pipe |
| 43 | Screw |
| 44 | Bevel gear |
| 45 | Crown wheel |
| 46 | Pinion gear |
| 47 | Electric motor |
| 48 | Heat exchanger |
| 49 | Heat exchanger |
| 50 | — |
| 51 | Separating system |
| 52 | Line |
| 53 | Membrane |
| 54 | First area |
| 55 | Second area |
| 56 | Line |
| 57 | Housing |
| 58 | Line |
| 59 | Line |
| 60 | Pump |
| 61 | Line |
| 62 | Drain pipe |
| 63 | Supply line |
| 64 | Heating apparatus |
| 65 | Combustion chamber |
| 66 | Spacer |
| 67 | Connector |
| 68 | Base |
| 69 | Cover |
| 70 | — |
| 71 | Opening |
| 72 | Annular space |
| 73 | Outside pipe |
| 74 | Outlet |

1. Apparatus for separating carbon and hydrogen in a hydrocarbon-containing gas mixture, in particular natural gas, wherein the apparatus has a rotationally-symmetrical housing with an essentially toroidal separating space with a vertical central axis, wherein the housing has an upper part, a side wall, a lower part for extracting carbon, and a dip pipe located in the vertical central axis with an opening for extracting the hydrogen, and wherein emptying into the upper part are two or more nozzles with a nozzle opening for injecting the gas mixture into the separating space, whose nozzle axis defining a beam axis has a component that is tilted in the peripheral direction of the separating space, a component that is tilted radially outward, and a component that is tilted in the vertical direction.

2. The apparatus according to claim 1, wherein the nozzle opening of at least one nozzle, preferably of a group of nozzles, lies on a first circle, whose midpoint lies in the vertical central axis, and wherein the nozzle axis of this nozzle lies in a normal projection tangentially to the circle.

3. The apparatus according to claim 2, wherein the nozzle opening of at least one nozzle, preferably of a group of nozzles, lies on a second circle, whose midpoint lies in the vertical central axis, and wherein the nozzle axis of this nozzle lies in a normal projection tangentially to the circle.

4. The apparatus according to claim 2, wherein the toroidal separating space has a central circle and wherein the diameter of the first and/or second circle is larger than the diameter of the central circle.

5. The apparatus according to claim 4, wherein the diameter of the first and/or second circle is smaller than the diameter of the central circle that is ⅓ larger.

6. The apparatus according to claim 1, wherein the separating space has a maximum outside diameter and wherein the nozzle axes of the nozzles are directed onto the area of the maximum outside diameter.

7. The apparatus according to claim 6, wherein the maximum outside diameter lies in a normal plane to the vertical central axis.

8. The apparatus according to claim 6, wherein the area in which the impact point of the respective nozzle axis lies on the housing lies at an angle of between 10°, preferably 5°, in particular 0°, below the normal plane, and 20°, preferably 17°, in particular 14°, above the normal plane, wherein the tip of the angle is at the point of intersection of the normal plane and the vertical central axis, and the angle from the normal plane is measured.

9. The apparatus according to claim 7, having vertical planes, in which the vertical central axis and the impact point of the respective nozzle axis are located on the housing, and wherein an angle between the normal projection of the respective nozzle axis onto the normal plane and the respective vertical plane is between 26° and 57°, preferably between 31° and 52°, in particular between 36° and 47°.

10. The apparatus according to claim 7, wherein an angle between a normal projection of a nozzle axis onto a vertical plane, in which the central axis and the impact point of the respective nozzle axis are located, and the normal plane is between 34° and 47°.

11. The apparatus according to claim 1, wherein the dip pipe extends from above through the upper part into the separating space.

12. The apparatus according to claim 1, wherein the separating space is bounded on the side opposite to the upper part by a base plate.

13. The apparatus according to claim 12, wherein an annular gap is formed between the base plate and the side wall, through which annular gap the carbon flows into the lower part.

14. The apparatus according to claim 12, wherein the base plate has a first recess that is in the shape of an arc of a circle in cross-section and that bounds the separating space.

15. The apparatus according to claim 12, wherein the base plate in the area in front of the opening of the dip pipe has a second recess that is in the shape of an arc of a circle in cross-section.

16. The apparatus according to claim 1, wherein the dip pipe outside of the housing is surrounded at least partially by a sheath for feeding the gas mixture.

17. The apparatus according to claim 16, wherein feed lines, which are connected to the nozzles, are connected to the sheath.

18. The apparatus according to claim 1, further comprising by a heating system for the gas mixture, which is suitable for heating the gas mixture to a temperature of at least 700°, preferably to a temperature up to 1,200°.

19. The apparatus according to claim 1, further comprising by a compressor, which is suitable for compressing the gas mixture to a pressure of at least 1.5 bar, preferably to a pressure up to 2.5 bar.

20. The apparatus according to claim 1, wherein a pipe is adjacent to the lower part, in which pipe preferably a screw that is driven by a motor is mounted to rotate, which screw preferably has a variable pitch.

21. The apparatus according to claim 20, wherein at least a first heat exchanger is arranged on the pipe.

22. The apparatus according to claim 1, wherein a separating system is connected to the dip pipe, which separating system, preferably via a membrane (53) that is permeable only to hydrogen, separates hydrogen from the gas mixture exiting from the separating space by the dip pipe.

23. The apparatus according to claim 16
wherein at least a first heat exchanger is arranged on the pipe,
wherein a separating system is connected to the dip pipe, which separating system, preferably via a membrane (53) that is permeable only to hydrogen, separates hydrogen from the gas mixture exiting from the separating space by the dip pipe, and
wherein the separating system is connected via a line to the first heat exchanger, and wherein the heat exchanger is connected via a line to the sheath.

24. The apparatus according to claim 23, wherein another heat exchanger is arranged between the line and the first heat exchanger, which other heat exchanger is connected to the first heat exchanger via a line.

25. The apparatus according to claim 22, wherein the separating system is connected via a supply line to a heating apparatus for heating the hydrocarbon-containing gas mixture.

26. Process for separating carbon and hydrogen in a hydrocarbon-containing gas mixture, in particular natural gas, wherein the gas mixture is fed under the action of centrifugal forces, in which the gas mixture is fed to a rotationally-symmetrical housing with an essentially toroidal separating space with a vertical central axis, wherein the housing has an upper part, a side wall, a lower part for extracting carbon, and a dip pipe located in the vertical central axis with an opening for extracting the hydrogen, and wherein the gas mixture is fed through two or more nozzles into the separating space, which nozzles are arranged in the upper part and have a nozzle axis defining a beam axis, which nozzle axis has a component that is tilted in the peripheral direction of the separating space, a component that is tilted radially outward, and a component that is tilted in the vertical direction.

27. The process according to claim 26, wherein the gas mixture is fed at a temperature of at least 600° C., preferably between 600° C. and 1,200° ° C., into the separating space.

28. The process according to claim 26, wherein the gas mixture is fed at a pressure of 1.5 to 2.5 bar into the separating space.

29. The process according to claim 26, wherein separated hydrogen is used for warming a heating apparatus to heat up the hydrocarbon-containing gas mixture.
